(19) United States
(12) Patent Application Publication
(10) Pub. No.: US 2007/0083012 A1
(43) Pub. Date: Apr. 12, 2007

(54) Curable polymer compound

(76) Inventors: Masanao Kamijo, Kanagawa (JP); Mina Onishi, Kanagawa (JP); Katsumi Murofushi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/579,066

(22) PCT Filed: Nov. 1, 2004
(86) PCT No.: PCT/JP04/16505

§ 371 Date: May 11, 2006

Related U.S. Application Data
(60) Provisional application No. 60/523,309, filed on Nov. 20, 2003.

(30) Foreign Application Priority Data
Nov. 12, 2003 (JP) 2003-382759

(51) Int. Cl. C08F 20/32

(52) U.S. Cl. 525/327.3

(57) ABSTRACT

There are provided a novel curable polymer compound of the present invention comprises having a structure represented by the following Formula (I):
CH₂═C(R¹)COO(R²O)ₙCH₂CH(OH)CH₂OOC— Formula (I)

wherein R¹ represents a hydrogen atom or a methyl group, R² independently has one or more organic residues selected from the group consisting of an alkylene group, a branched alkylene group, an alkenylene group, a branched alkenylene group, a cycloalkylene group, a cycloalkenylene group and an arylene group, and n represents an integer of 0 to 1, a method of preparing the polymer compound, a radical polymerizable and curable composition using the polymer compound, and a cured product obtained by photo-curing the radical polymerizable and curable composition.

### CROSS-REFERENCES TO RELATED APPLICATIONS

This application claims benefit under 35 U.S.C. §119(e) to U.S. Provisional Application Ser. No. 60/523309, filed Nov. 20, 2003.

### TECHNICAL FIELD

The present invention relates to a novel curable polymer compound, a method of preparing said polymer compound, radical polymerizable and curable composition using said polymer compound, and a cured product obtained by photo-curing said radical polymerizable and curable composition.

More specifically, the present invention relates to a curable polymer compound having a pattern-forming property due to a developing property an aqueous alkaline solution imparted by the addition of a radical polymerizable group so as to permit photo-curing by the simultaneous introduction of a carboxyl group, a method of preparing said polymer compound, and a radical polymerizable and curable composition using said polymer compound.

### BACKGROUND ART

In recent years, photo-curing resins that can be cured by photo energy such as an ultraviolet ray or an electron beam have been widely used in the fields of printing, paints, adhesives and the like from a viewpoint of energy saving.

Specifically, from a productivity viewpoint, radical polymerizable and curable resins have been preferably used in etching resists for making circuits for use in the filed of electronic equipment, solder resists for protecting circuit boards for a long time, color filter resists for generating each pixel for color filters, and black matrix resists for color filters in order to divide each pixel and thereby to enhance contrast.

Illustrative examples of such resins include an epoxyacrylate resin described on pp. 353-355 in the Polyester Resin Handbook (published by Nikkan Kogyo Shimbun, Ltd. in 1988), a resin in which a polybasic acid anhydride was added to a hydroxy group that was formed after adding acrylic acid to a copolymer of glycidyl methacrylate described in Japanese Unexamined Patent Publication (Kokai) No. 2001-89553, and a resin in which a (meth)acrylate compound having an alicyclic epoxy group was added to the carboxyl group of the side chain of the acrylic copolymer or a styrenic copolymer described in Japanese Unexamined Patent Publication (Kokai) No. 10-253815 and Japanese Unexamined Patent Publication (Kokai) No. 10-253816.

However, these resins had drawbacks that the surface of a coated film is vulnerable to radical polymerization inhibition by oxygen, stickyness tends to persist, and they do not provide sufficient photo sensitivity.

A method of adding a photo radical polymerization initiator in large quantities has been adopted in order to resolve these problems. However, there were also problems that, depending on the type of photo radical polymerization initiators, precipitates derived from the photo polymerization initiators may be formed in the alkaline development tank resulting in the contamination of the alkaline development tank, or the residual photo radical polymerization initiators may sublime during post-curing of the resist resulting in the contamination of the heating furnace or the exhaust duct, and the like.

As used herein, “(meth)acryl” means “methacryl” and/or “acryl.” The same holds true for “(meth)acryloyl.”

As methods of suppressing polymerization inhibition by oxygen, a method of curing and crosslinking with a thiyl radical that is rather refractory to inhibition by oxygen and a method of adding a polyfunctional thiol are also being investigated (Japanese Unexamined Patent Publication (Kokai) No. 10-253815, Japanese Unexamined Patent Publication (Kokai) No. 10-251816, and Japanese Unexamined Patent Publication (Kokai) No. 2000-249822. These methods, however, had problems that during storage mercapto groups and (meth)acryloyl groups may react due to Michael addition resulting in poor storage stability.

Efforts have also been made to introduce an allyl ether group. In Japanese Examined Patent Publication (Kokoku) No. 1-51487, for example, an allyl group has been introduced by reacting a trimethylolpropane diallyl ether reactant of methacrylic acid and phthalic anhydride to an epoxy resin in order to circumvent polymerization inhibition by oxygen. However, the ally ether group has poor radical polymerizability and hence is not sufficient in terms of the polymerization speed.

From the foregoing, there is a need for a polymer compound having a favorable radical polymerizability and an excellent alkaline developing property, and for a radical polymerizable and curable composition containing said compound.

It is an object of the present invention to solve the above problems, to provide a novel polymer compound having a favorable radical polymerizability and an excellent alkali developing property, a method of preparing said radical polymerizable resin, and a radical polymerizable and curable composition that employs said radical polymerizable resin.

After intensive and extensive research to solve the above problems, the present inventors have found that by a novel polymer compound that can be obtained by using as raw materials a copolymer of (meth)acrylic acid and styrene or substituted styrene and (meth)acrylic ester having a specific epoxy group and reacting them, there can be provided a radical polymerizable and curable composition having a favorable radical polymerizability and an excellent alkaline developing property, and therefore have completed the present invention.

### SUMMARY OF THE INVENTION

Thus, the present invention relates to [1] to [14] described below.
[1] A polymer compound whose side chain has a structure represented by the following Formula (I):
   CH₂═C(R¹)COO(R²O)ₙCH₂CH(OH)CH₂OOC— Formula (I)

wherein R¹ represents a hydrogen atom or a methyl group, R² independently has one or more organic residues selected from the group consisting of an alkylene group, a branched alkylene group, an alkenylene group, a branched alkenylene group, a cycloalkylene group, a cycloalkenylene group and an arylene group, and n represents an integer of 0 to 1.
[2] The polymer compound according to [1] wherein the polymer compound residue representing the main chain is a copolymer of (meth)acrylic acid and styrene and/or substituted styrene.
[3] A method of preparing the polymer compound according to [1] or [2] comprising the following Preparation step A wherein

to a polymer compound represented by the following Formula (2):
R³—(—COOH)ₘ Formula (2)

wherein R³ is a polymer compound residue representing the main chain and m represents an integer of 2 or more is reacted one or more of compounds represented by the following Formula (3):

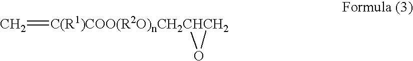

wherein R¹ represents a hydrogen atom or a methyl group, R² independently has one or more organic residues selected from the group consisting of an alkylene group, a branched alkylene group, an alkenylene group, a branched alkenylene group, a cycloalkylene group, a cycloalkenylene group and an arylene group, and n represents an integer of 0 to 1, in an additive reaction.
[4] The method of preparation according to [3] wherein the addition reaction in the above Preparation step A is carried out in the presence of a catalyst.
[5] The method of preparation according to [4] wherein said catalyst comprises one or more catalysts selected from the group consisting of a metal halide, a tertiary amine, a pyridine compound, a pyridinium salt, a quaternary ammonium salt, a phosphine compound, a phosphonium salt, and an imidazole compound.
[6] The method of preparation according to [5] wherein said catalyst comprises one or more catalysts selected from the group consisting of benzyltrimethyl ammonium chloride, benzyltriethyl ammonium chloride, tetrabutyl ammonium bromide, triphenyl phosphine, ethyltriphenyl phosphonium bromide, tetraphenyl phosphonium bromide, benzyltriphenyl phosphonium chloride, and 2-methyl imidazole.
[7] A curable composition comprising the polymer compound according to [1] or [2].
[8] The curable composition according to [7] comprising the polymer compound according to [1] or [2] and an ethylenic unsaturated compound.
[9] The curable composition according to [7] or [8] further comprising a radical polymerization initiator.
[10] The curable composition according to [9] wherein said radical polymerization initiator is a photo radical polymerization initiator.
[11] The curable composition according to [9] or [10] comprising a polyfunctional thiol compound that has one or more than one mercapto group.
[12] The curable composition according to [11] wherein said polyfunctional thiol is a polyfunctional thiol compound having two or more mercapto-containing groups in which the carbon atom at position a and/or position β relative to the mercapto group has a substituent group.
[13] A curable composition for color filters which composition comprises a curable composition according to any of [7]-[12].
[14] A cured product for color filters having a pattern that is obtained by a process wherein a curable composition according to any of [7]-[12] is coated on a substrate, which is then exposed to light and cured through a photomask, and the uncured portions are washed away with an aqueous alkaline solution.

### DETAILED DESCRIPTION OF THE INVENTION

The best mode for carrying out the present invention will now be explained below.

1. Polymer Compound

The curable polymer compound of the present invention comprises having one or more of the structure represented by the following Formula (I):
CH₂═C(R¹)COO(R²O)ₙCH₂CH(OH)CH₂OOC— Formula (I)

wherein R¹ represents a hydrogen atom or a methyl group, R² independently has one or more organic residues selected from the group consisting of an alkylene group, a branched alkylene group, an alkenylene group, a branched alkenylene group, a cycloalkylene group, a cycloalkenylene group and an arylene group, and n represents an integer of 0 to 1.

The side chain as used herein is a branched portion that is directly or indirectly bound to a liner polymer constituting the main chain, and contains the partial structure of Formula (I). The curable polymer compound of the present invention may have a plurality of partial structures of Formula (I) as side chains, in which case R¹, R² and n may differ in each of the structures of Formula (I). The curable polymer compound of the present invention may have structures as side chains other than the partial structure of Formula (I).

The side chain of Formula (I) of the curable polymer compound of the present invention has a (meth)acryloyl group on the end thereof. Since the (meth)acryloyl group is located remote from the main acrylic chain, it is highly reactive. Thus it has an extremely good radical polymerizability, and hence even a small amount of the photo radical polymerization initiator can carry out polymerization in an efficient manner.

Furthermore, the polymer compound of the present invention preferably has a carboxyl group. The carboxyl group is introduced into the polymer compound of the present invention for the purpose of imparting an alkaline developing property.

As R¹ in Formula (I), a hydrogen atom or a methyl group is preferred, and a hydrogen atom is more preferred from a viewpoint of reactivity.

As specific examples of R² in Formula (I), there can be mentioned a linear alkylene group such as a methylene group, an ethylene group, a propylene group, a butylene group, a pentylene group, a hexylene group, a heptylene group, an octylene group, a nonilene group, and a decylene group; a cycloalkylene group such as a cyclopropylene group, a cyclobutylene group, a cyclopentylene group, a cyclohexylene group, a cycloheptylene group, a cyclooctylene group, a dicyclopentylene group, and a tricyclopentylene group; a branched alkylene group such as a methylethylene group; an aralkylene group such as a phenylethylene group and a 1,2-diphenylethlene group; and an arylene group such as a phenylene group, a naphthylene group and an anthranylene group. However the present invention is not limited to these examples in any way.

According to the present invention, from a viewpoint of availability of raw materials and easiness of synthesis, the structure of Formula (I) is Formula (4) to (5):
CH₂═C(CH₃)COOCH₂CH(OH)CH₂OOC— Formula (4)
CH₂═C(H)COOC₄H₈OCH₂CH(OH)CH₂OOC— Formula (5)
preferably.

The purpose of introducing an (meth)acryloyl group of Formula (3) into the polymer compound of the present invention is to impart or enhance the photo curing property, and it is an extremely effective means to increase the curing speed. However, if the amount of the (meth)acryloyl group is too large, photo sensitivity becomes too high and thus the control of hardness becomes difficult, and conversely if the amount of the (meth)acryloyl group is too small, photo curing becomes insufficient. Since acryloyl groups are more reactive than metacryloyl groups, when the polymer compound of the present invention contains acryloyl groups and metacryloyl groups simultaneously, the relative content of acryloyl groups and metacryloyl groups must be selected to be in an appropriate range considering the desired curing speed. The molar ratio of the number of acryloyl groups and that of metacryloyl groups contained in the polymer compound of the present invention is preferably 10-90:90-10, and more preferably 20-80:80-20.

In order to impart alkaline solubility (developing property), the polymer compound of the present invention preferably has carboxyl groups derived from (meth)acrylic acid in the main chain. The acid value (it means solid acid value, it is determined pursuant to JIS K0070. The same hereinbelow) for the polymer compound of the present invention to have an appropriate alkaline developing property is preferably 30 mgKOH/g or greater, more preferably in the range of 45 mgKOH/g to 160 mgKOH/g, and most preferably 50 mgKOH/g to 140 mgKOH/g, since it has a favorable balance of the alkaline solubility of the uncured film and the alkali resistance of the cured film.

In order to impart alkali resistance, the polymer compound of the present invention preferably has monomer units derived from styrene or substituted styrene in the main chain. If the ratio of styrene or substituted styrene in the main chain becomes too low, resistance of the cured film to aqueous alkaline solutions becomes low, and conversely if the ratio of styrene or substituted styrene in the main chain is too high, the number of reactive groups becomes decreased and hence photo curing becomes insufficient. Therefore, the ratio of styrene and substituted styrene in the main chain must be selected considering the curing speed and alkali resistance.

The main chain of the curable polymer compound of the present invention is preferably a copolymer of (meth)acrylic acid and styrene or substituted styrene because of easiness of controlling film properties and resistance to aqueous alkaline solutions. Monomers other than these may be copolymerized. The molar ratio of (meth)acrylic acid and styrene or substituted styrene in the main chain of the curable polymer compound of the present invention is preferably 10-90:90-10, and more preferably 20-80:80-20.

2. Preparation Step of a Curable Polymer Compound

The present invention relates to a method of preparing the polymer compound of the present invention comprising the following Preparation step A. The Preparation step A is a reaction process in which the epoxy group of the compound of Formula (3) is added to a portion of the carboxyl group of the polymer compound of Formula (2) having a carboxyl group.

The Preparation Step A

A preparation step in which

to a polymer compound represented by the following Formula (2):
R³—(—COOH)ₘ Formula (2)

wherein R³ represents a polymer compound residue and m represents an integer of 2 or greater is added

one or more compounds represented by the following Formula (3):

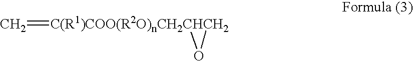

wherein R¹ represents a hydrogen atom or a methyl group, R² has one or more organic residues independently selected from the group consisting of an alkylene group, a branched alkylene group, an alkenylene group, a branched alkenylene group, a cycloalkylene group, a cycloalkenylene group and an arylene group, and n represents an integer of 0 to 1 in an addition reaction.

In Formula (2), R³ represents a polymer compound residue, and more specifically a polymer compound having a carboxyl group in the molecule. Such a polymer compound herein is a (meth)acrylic acid copolymer having a carboxyl group because of easiness of controlling the physical properties of the coated film.

(Meth)acrylic acid copolymers can be obtained by the radical polymerization of a) an ethylenic unsaturated compound having a carboxyl group, and b) an ethylenic unsaturated compound other than a) in an organic solvent by a known method. b) is used for the purpose of controlling the physical properties of the coated film.

a) As specific examples of ethylenic unsaturated compounds having a carboxyl group, there can be mentioned unsaturated monocarboxylic acid such as acrylic acid, methacrylic acid, crotonic acid, α-chloroacrylic acid, ethylacrylic acid, and cinnamic acid; unsaturated dicarboxylic acids (anhydrides) such as maleic acid, maleic anhydride, fumaric acid, itaconic acid, itaconic anhydride, citraconic acid, and citraconic anhydride; or trivalent or greater unsaturated carboxylic acids (anhydrides), and the like. Among them, acrylic acid and methacrylic acid are preferred. These unsaturated carboxylic acid monomers may be used alone or in combination.

b) As specific examples of ethylenic unsaturated compounds other than a), there can be mentioned vinyl compounds such as styrene, α-methylstyrene, (o, m, p-)hydroxystyrene and vinyl acetate; (meth)acrylates such as methyl(meth)acrylate, ethyl(meth)acrylate, n-propyl(meth)acrylate, isopropyl(meth)acrylate, n-butyl(meth)acrylate, sec-butyl(meth)acrylate, tert-butyl(meth)acrylate, n-hexyl(meth)acrylate, cyclohexyl(meth)acrylate, benzyl(meth)acrylate, phenoxyethyl(meth)acrylate, isobornyl(meth)acrylate, dicyclopentanyl(meth)acrylate, dicyclopentenyl(meth)acrylate, dicyclopentanyloxyethyl(meth)acrylate, dicyclopentenyloxyethyl(meth)acrylate, tetrahydrofurfuryl(meth)acrylate, (meth)acrylonitrile, 2-hydroxyethyl(meth)acrylate, 2-hydroxypropyl(meth)acrylate, N,N-dimethylaminoethyl(meth)acrylate, trifluoroethyl(meth)acrylate, 2,2,3,3-tetrafluoropropyl(meth)acrylate and perfluorooctylethyl(meth)acrylate; compounds having amide groups such as (meth)acrylamide, N,N-dimethyl(meth)acrylamide, N,N-dietyl(meth)acrylamide, N-metyl(meth)acrylamide, N-ethyl(meth)acrylamide, N-isopropyl(meth)acrylamide, N-vinylpyrrolidone, N-vinylcaprolactam and N-(meth)acryloylmorpholine. These ethylenic unsaturated compounds other than a) may be used alone or in combination.

Ethylenic unsaturated compounds other than a) are preferably styrene and substituted styrene such as α-methylstyrene and (o, m, p-)hydroxystyrene.

The copolymerization ratio of a) and b) is preferably a molar ratio of 10:90 to 90:10, more preferably 20:80 to 80:20. If the copolymerization ratio of a) is less than 5, radical polymerization becomes decreased. If the copolymerization ratio of a) is greater than 90, storage stability becomes poor.

A preferred molecular weight of (meth)acrylic acid copolymers having carboxyl groups for use in the present invention is in the range of 1,000-500,000, preferably 3,000-200,000 as weight mean molecular weight in terms of polystyrene measured by GPC. If it is less than 1,000, the strength of coated film after curing decreases significantly. On the other hand, if it exceeds 500,000, the alkali developing property decreases significantly.

In the curable polymer compound of the present invention, preferably the main chain is a copolymer of (meth)acrylic acid and styrene or substituted styrene, and the side chain has the structure of Formula (3). The carboxyl groups in the main chain derived from (meth)acrylic acid become reaction points for adding the structure of Formula (3), but if all of them are reacted, the alkali developing property is lost, which is not preferred.

Copolymers of (meth)acrylic acid and styrene or substituted styrene can be obtained by radical polymerization thereof using a polymerization initiator in an organic solvent. However, the reaction is preferably carried out in an organic solvent inert (non-reactive) to the epoxy group, considering that an ethylenic unsaturated compound having an epoxy group is added to the carboxyl group in a later stage of the Preparation step A. As specific examples of such organic solvents, there can be mentioned benzene, toluene, xylene, tetrahydrofuran, dibutylether, diethyleneglycol dimethylether, ethyleneglycol diethylether, propylene glycol monomethylether acetate, propylene glycol monoethylether acetate, diethylene glycol ethylether acetate, methyl methoxypropionate, ethyl methoxypropionate, methyl ethoxypropionate, ethyl ethoxypropionate, ethyl acetate, isoamyl acetate, ethyl lactate, acetone, methylethylketone, cyclohexanone, N,N-dimethylformamide, N-methylpyrrolidone, and the like.

As a radical polymerization initiator for use in this copolymerization reaction, there can be mentioned azo compounds such as 2,2′-azobisisobutylonitrile and 2,2′-azobisisovalerylonitrile; ketone peroxides such as methylethylketone peroxide, methylisobutylketone peroxide and cyclohexanone peroxide; diacyl peroxides such as benzoyl peroxide, decanoyl peroxide and lauroyl peroxide; dialkyl peroxides such as dicumyl peroxide, t-butylcumyl peroxide and di-t-butylperoxide; peroxyketals such as 1,1-bis(t-hexylperoxy) 3,3,5-trimethyl cyclohexane and 1,1-di-t-butylperoxy cyclohexane and 2,2-di(t-butylperoxy)buatne; alkylperoxyesters such as t-butylperoxy pivalate, t-butylperoxy-2-ethyl hexanoate, t-butylperoxy isobutylate, di-t-butylperoxyhexahydro terephthalate, di-t-butylperoxy azelate, t-butylperoxy-3,5,5-trimethyl hexanoate, t-butylperoxy acetate, t-butylperoxy benzoate, di-t-butylperoxy trimethyl adipate, t-butylperoxy 2-ethylhexanoate and t-hexyl peroxy 2-ethyl hexanoate; and percarbonatges such as diisopropyl peoxy dicarbonate, di-sec-butylperoxy dicarbonate, and t-butylperoxy isopropyl carbonate.

As specific examples of ethylenic unsaturated compounds having epoxy groups represented by Formula (3) that are added to carboxyl groups derived from acrylic acid, there can be mentioned glycidyl (meth)acrylate, 3,4-epoxyclohexylmethyl (meth)acrylate, 4-(2,3-epoxypropoxy)butyl(meth)acrylate, allylglycidylether and 4-hydroxybutylacrylate glycidylether. Among them, from the viewpoint of availability and enhanced hardenability, glycidyl (meth)acrylate and 4-hydroxybutylacrylate glycidylether are preferred.

In the Preparation step A of the present invention, catalysts are preferably used to promote reactions. Catalysts may be, but not limited to, those generally used in the reaction of a carboxyl group and an epoxy group. As specific examples of catalysts used, there can be mentioned metal halides such as aluminum chloride, tin chloride and zinc chloride; pyridine compounds such as pyridine, α-picoline, isoquinoline and quinoline; pyridinium salts such a N-methylpyridinium chloride and N-ethylpyridinium chloride; quaternary ammonium salts such as benzyltrimethylammonium chloride, benzyltriethylammonium chloride, benzyltriethylammonium chloride and tert-butylammonium bromide; phosphine compounds such as triphenyl phosphine; phosphonium salts such as ethyltriphenylphosphonium bromide, tetraphosphonium bromide and benzyltriphenyl phosphonium chloride; hydroxides such as sodium hydroxide, potassium hydroxide and lithium hydroxide; carbonates such as potassium carbonate and calcium carbonate; and imidazole compounds such as 2-methyl imidazole, 2-ethyl-4-methyl imidazole and 2-phenyl imidazole.

From the easy availability and the speed of the addition reaction among them, benzyltrimethylammonium chloride, benzyltriethylammonium chloride, tetrabutylammonium bromide triphenyl phosphine, ethyl phenyl phosphonium bromide, tetraphenylphosphonium bromide, benzyltriphenyl phosphonium chloride and 2-methyl imidazole are specifically preferred.

The reaction temperature of the addition reaction of the Preparation step A of the present invention is generally, but not limited to, 0° C.-20° C., preferably 20° C.-150° C., and more preferably 50° C.-120° C. At 0° C., the reaction becomes very slow, whereas at 200° C. or higher polymerization or decomposition may take place and thus is not undesirable.

In the addition reaction of Preparation step A, organic solvents may be used. Especially when solids or high-viscosity materials are used, agitation becomes difficult and thus the use of organic solvents is preferred. Organic solvents that can be used may be any solvents unless they do not inhibit the addition reaction, and there can be mentioned benzene, toluene, xylene, dibutylether, diethyleneglycol dimethylether, ethyleneglycol diethylether, propylene glycol monomethylether acetate, propylene glycol monoethylether acetate, diethylene glycol ethylether acetate, methyl methoxypropionate, ethyl methoxypropionate, methyl ethoxypropionate, ethyl ethoxypropionate, ethyl acetate, isoamyl acetate, ethyl lactate, acetone, methylethylketone, cyclohexanone, N,N-dimethylformamide, N-methylpyrrolidone, and the like. These solvents may be used alone or in combination of two or more.

The feeding ratio of materials of the addition reaction in the Preparation step A is the number of moles of the epoxy groups in the compound represented by Formula (3) is 0.1-0.9 mole, preferably 0.2-0.8 mole relative to one mole of the carboxyl groups in the compound represented by Formula (2). If the mole number of the epoxy groups in the compound represented by Formula (3) is smaller than 0.1 mole relative to one mole of the carboxyl groups of the compound represented by Formula (2), curing properties does not develop due to insufficient (meth)acryloyl groups. On the other hand, if it is greater than 0.9 mole, the control of photo curing becomes difficult due to an excess of (meth)acryloyl groups, and alkali solubility becomes poor due to insufficient carboxyl groups, and thus it is not desirable. The feeding ratio of the materials must be determined considering the balance between the structure represented by Formula (1) that contributes to curing properties and the number of carboxyl groups that contribute the alkali developing property.

The amount of the catalyst for use in the Preparation step A is 0.01-10 parts by weight, preferably 0.1-5 parts by weight, and more preferably 0.1-3 parts by weight relative to 100 parts by weight of a total of the compound represented by Formula (2) and the compound represented by Formula (3). If the amount is smaller than 0.01 part by weight, the reaction rate becomes slow and hence the heating time is extended, which has a risk of heat-polymerizing the polymerizing compound produced and thus is not desirable. If the amount is greater than 10 parts by weight, pigmentation becomes pronounced which is not desirable, either.

Furthermore, in order to suppress unintended heat-polymerization and curing reaction of the polymer compound produced in the Preparation step A, polymerization inhibitors may be used. As polymerization inhibitors that can be used, there can be mentioned, but not limited to, quinones such as p-benzoquinone and 2,5-diphenyl-p-benzoquinone and common radical polymerization inhibitors such as hydroquinone, hydroquinone monomethylether, p-t-butyl catechol, 2,5-di-t-butyl hydroquinone, mono-t-butyl hydroquinone and phenothiazine.

3. Curable Compositions

The curing composition of the present invention will now be explained in more detail.

The curing composition of the present invention relates to curable compositions in which at least one of the polymer compound of the present invention is required.

The curable composition of the present invention can be obtained by mixing the polymer compound of the present invention with various ethylenic unsaturated compounds, solvents, photo- or heat-radical polymerization initiators, as desired.

Ethylenic unsaturated compounds that can be used in the present invention are any compounds that have a radical polymerizing property, and those having two or more ethylenic unsaturated groups are preferred.

As monomers as ethylenic unsaturated compounds, there can be mentioned the following compounds: alkyl(meth)acrylates such as methyl(meth)acrylate, ethyl(meth)acrylate, propyl(meth)acrylate, n-butyl(meth)acrylate, isopropyl(meth)acrylate, sec-butyl(meth)acrylate, tert-butyl(meth)acrylate, hexyl(meth)acrylate, octyl(meth)acrylate, isooctyl(meth)acrylate, 2-ethylhexyl(meth)acrylate, decyl(meth)acrylate, lauryl(meth)acrylate and stearyl(meth)acrylate; alicyclic(meth)acrylates such as cyclohexyl(meth)acrylate, bornyl(meth)acrylate, isobornyl(meth)acrylate, dicyclopentenyl(meth)acrylate and dicyclopentenyloxyethyl(meth)acrylate; aromatic(meth)acrylates such as benzyl(meth)acrylate, phenyl(meth)acrylate, phenylcarbitol(meth)acrylate, nonylphenyl(meth)acrylate, nonylphenylcarbitol(meth)acrylate, and nonylphenoxy(meth)acrylate;(meth)acrylates having hydroxyl groups such as 2-hydroxyethyl(meth)acrylate, hydroxypropyl(meth)acrylate, hydroxybutyl(meth)acrylate, butanediol mono(meth)acrylate, glycerol(meth)acrylate, polyethylene glycol(meth)acrylate and glycerol di(meth)acrylate;

(meth)acrylates having amino groups such as 2-dimethylaminoethyl(meth)acrylate, 2-diethylaminoethyl(meth)acrylate and 2-tert-butylaminoethyl(meth)acrylate; methacrylates having phosphorus atoms such as methacryloxyethyl phosphate, bis methacryloethyl phosphate and methacryloxyethylphenol acid phosphate; di(meth)acrylates such as ethylene glycol di(meth)acrylate, diethylene glycol di(meth)acrylate, triethylene glycol di(meth)acrylate, tetraethylene di(meth)acrylate, polyethylene glycol di(meth)acrylate, propylene glycol di(meth)acrylate, dipropylene glycol di(meth)acrylate, tripropylene glycol di(meth)acrylate, 1,4-butandiol di(meth)acrylate, 1,3-butanediol di(meth)acrylate, neopentyl glycol di(meth)acrylate, 1,6-hexanediol di(meth)acrylate and bis glycydyl(meth)acrylate;

poly(meth)acrylates such as trimethylolpropane tri(meth)acrylate, pentaerythritol tri(meth)acrylate and dipentaerythritol hexa(meth)acrylate; denatured polyol poly(meth)acrylates such as 4 mole-ethyleneoxide-added (meth)acrylate of bisphenol S, 4 mole-ethyleneoxide-added (meth)acrylate of bisphenol A, fatty acid-denatured pentaerythritol di(meth)acrylate, 3 mole-propyleneoxide-added tri(meth)acrylate of trimethylolpropane and 6 mole-propyleneoxide-added tri(meth)acrylate of trimethylolpropane;

polyacrylates having an isocyanuric acid backbone such as bis(acryloyloxyethyl) monohydroxyethyl isocyanurate, tris(acryloyloxyethyl) isocyanurate and ε-caprolactone-added tris(acryloyloxyethyl)isocyanurate; polyester acrylates such as α,ω-diacryloyl-(bisethyleneglycol)-phthalate, α,ω-tetraacryloyl-(bistrimethylolpropane)-tetrahydrophthalate; glycidyl(meth)acrylate; allyl(meth)acrylate; ω-hydroxyhexanoyloxyethyl(meth)acrylate; polycaprolactone(meth)acrylate; (meth)acryloyloxyethyl phthalate; (meth)acryloyloxyethyl succinate; 2-hydroxy-3-phenoxypropyl acrylate; phenoxyethyl acrylate; N-vinyl compounds such as N-vinyl pyrrolidone, N-vinyl formamide and N-vinyl acetamide.

As oligomers, there can be mentioned polyester(meth)acrylate, urethane(meth)acrylate and epoxy(meth)acrylate.

As resins, there can also be used (meth)acrylic ester copolymers having ethylenic unsaturated groups in the side chain such as are obtained by reacting an epoxy group of a compound having an epoxy group and an ethylenic unsaturated group in one molecule such as 3,4-epoxycyclohexylmethyl(meth)acrylate, 4-(2,3-epoxypropoxy)butyl(meth)acrylate and allylglycidyl ether to a carbonyl group of part of the side chain of a (meth)acrylic ester copolymer, or by reacting an isocyanate group of a compound having an isocyanate group and an ethylenic unsaturated group in one molecule such as 2-methacryloyloxyethyl isocyanate to a hydroxyl group of part or all of a (meth)acrylic ester copolymer.

As preferred examples of these ethylenic unsaturated compounds, there can be mentioned, in terms of enhanced curing properties, poly(meth)acrylates such as trimethylolpropane tri(meth)acrylate, pentaerythritol tetra(meth)acrylate and dipentaerythritol hexa(meth)acrylate.

The curable composition of the present invention can be cured by an active energy beam such as an electronic beam, γ ray, X-ray, ultraviolet ray, visible light and near-infrared ray. When a high-energy beam such as electronic beam and γ ray is used in curing, curing may be accomplished without an initiator (no catalysts). However, resist applications such as etching resists, solder resists and color filter resists are intended in which a light with a wavelength of 200-500 nm has to be used in curing, it is preferred to contain a photo radical polymerization initiator. As used herein, photo radical polymerization initiator means a photo radical generating agent alone or combinations with a photo radical generating agent, sensitizer and a chain transfer agent.

As specific examples of such photo radical generating agents, there can be mentioned acetophenone compounds such as 2-hydroxy-2-methyl-1-phenylpropane-1-one, 1-(4-isopropylphenyl)-2-methylpropane-1-one, 1-(4-butylphenyl)-2-hydroxy-2-methylpropane-1-one, 1-(4-methoxyphenyl)-2-methylpropane-1-one, 1-(4-methylthiophenyl)-2-methylpropane-1-one, 1-hydroxycyclohexyl phenylketone, 2-hydroxy-1-(4-(2-hydroxyethoxy)-phenyl)-2-methylpropane-1-one, 2-methyl-1-[(4-methylthiolphenyl)-2-morpholino-propane-1-one, 2-benzyl-2-dimethylamino-1-(4-morpholinophenyl)-butane-1-one and 2-benzyl-2-dimetylamino-1-(4-dimethylaminophenyl)-butane-1-one; benzoin compounds and their derivatives such as benzoin methylether, benzoin ethylether, benzoin isopuropylether, benzyldimethylketal and benzyl; acylphosphine oxide compounds such as 2,4,6-trimethylbenzoyl diphenylphosphine oxide and bis(2,6-dimethoxybenzoyl)-2,4,6-trimethylpentylphosphine oxide; hexaryl biimidazole compounds such as 2,2′-bis(o-chlorophenyl)-4,4′,5,5′-tetraphenyl-1,2′-biimidazole, 2,2′-bis(o-bromophenyl)-4,4′,5,5′-tetraphenyl-1,2′-biimidazole, 2,2′-bis(o-fluorophenyl)-4,4′,5,5′-tetraphenyl-1,2′-biimidazole, 2,2′-bis(o,p-dichlorophenyl)-4,4′,5,5′-tetraphenyl-1,2′-biimidazole, 2,2′-bis(2-chlorophenyl)-4,4′-5,5′-tetrakis(4-metylphenyl)-1,2′-biimidazole and 2,2′-bis(2-chlorophenyl)-4,4′-5,5′-tetrakis(4-methoxyphenyl)-1,2′-biimidazole; compounds such as methylphenyl glyoxylate, α-acyloxime ester and camphorquinone; organic boric salt compounds described in Japanese Unexamined Patent Publication (Kokai) No. 2000-249822, titanocen compounds described in Japanese Unexamined Patent Publication (Kokai) No. 4-221958 and Japanese Unexamined Patent Publication (Kokai) No. 4-21975, and triazine compounds described in Japanese Unexamined Patent Publication (Kokai) No. 10-253815.

These photo radical generating agents may be used alone or in combination of two or more agents.

For the above photo radical generating agents, in order to enhance sensitivity, common sensitizers for use in usual photo radical polymerization initiators may be used, but in order to further enhance sensitivity, preferably one or more compounds selected from the group consisting of benzophenone compounds, thioxanthone compounds and ketocoumarin compounds may be used.

Specifically, there can be used benzophenone compounds such as benzophenone, 2,4,6-trimethyl benzophenone, 4-phenyl benzophenone, 4-benzoyl-4′-methyldiphenyl sulfide, 4,4′-bis(dimethylamino)benzophenone and 4,4′-bis(diethylamino)benzophenone; thioxanthone compounds such as thioxanthone, 2-methylthioxanthone, 2,4-dimethylthioxanthone, 2,4-diethylthioxanthone, isopropylthioxanthone, 2,4-diisopropylthioxanthone and 2-chlorothioxanthone; ketocoumarin compounds such as 3-acetylcoumarin, 3-acetyl-7-diethylaminocoumarin, 3-benzoylcoumarin, 3-benzoyl-7-diethylaminocoumarin, 3-benzoyl-7-methoxycoumarin, 3,3′-carbonylbis(7-methoxycoumarin), and 3,3′-carbonylbis(5,7-dimethoxycoumarin). One of more than one of them may be mixed and used.

The amount of the photo radical polymerization initiator in the curable composition of the present invention is preferably 0.1-40 parts by weight per 100 parts by weight of the compound (polymer compounds of the present invention, ethylenic unsaturated compounds etc.) having ethylenic unsaturated groups in the curable composition, and more preferably 0.5-30 parts by weight.

For the curable composition of the present invention, there can be mentioned, as part of the photo radical polymerization initiator system, a thiol compound as a chain transfer agent, specifically a polyfunctional thiol compound having one or more than one mercapto group. The addition of a polyfunctional thiol further suppresses polymerization inhibition by oxygen leading to highly sensitive photo radical polymerizable and curable compositions. As specific examples of such polyfunctional thiol compounds, there can be mentioned hexanedithiol, decanedithiol, 1,4-butanediol bis(2-mercaptopropionate), 1,4-butanediol bis(mercaptoacetate), ethyleneglycol bis(mercaptoacetate), ethyleneglycol bis(3-mercaptopropionate), trimethylolpropane tris(mercaptoacetate), trimethylolpropane tris(3-mercaptopropionate), pentaerythritol tetrakis(mercaptoacetate) and pentaerythritol tetrakis(3-mercaptopropionate).

However, in the case of polyfunctional thiol compounds having the above primary mercapto groups, mercapto groups and ethylenic unsaturated groups such as (meth)acryloyl groups may react during storage, resulting in reduced sensitivity after storage. Thus, in order to attain storage stability, it is preferred to use polyfunctional branched thiol compounds having two or more mercapto-containing groups in which carbon atoms at position α and/or β relative to the mercapto group have substituents. As used herein, at least one of the above substituents is preferably an alkyl group.

More preferably, they are polyfunctional branched thiol compounds having a structure which is branched at position α and/or β relative to the mercapto group, or polyfunctional branched thiol compounds having a structure in which carbon atoms at position α and/or β are bound to three or more atoms other than the hydrogen atom, or a so-called branched structure, for example thiol compounds in which at least one of the substituents other than the main chain at position α and/or β relative to the mercapto group. As used herein, the main chain represents the longest chain structure composed of atoms other than the hydrogen atom including the mercapto group.

Among them, specifically preferred is a polyfunctional thiol compound wherein said mercapto-containing group is represented by the following Formula (6):
—(CH₂)ₖC(R⁴)(R⁵)(CH₂)ⱼSH Formula (6)

wherein each of R⁴ and R⁵ represents independently a hydrogen atom or an alkyl group having 1-10 carbons, and at least one of them is an alkyl group. k represents an integer of 0-2 and j represents an integer of 0 or 1.

As specific examples of the polyfunctional thiol compounds having the mercapto group structure portion of Formula (6), there can be illustrated ethyleneglycol bis(3-mercaptobutylate), 1,2-propyleneglycol bis(3-mercaptobutylate), diethyleneglycol bis(3-mercaptobutylate), 1,4-butanediol bis(3-mercaptobutylate), 1,8-octanediol bis(3-mercaptobutylate), trimethylolpropane tris(3-mercaptobutylate), pentaerythritol tetrakis(3-mercaptobutylate), dipentaerythritol hexakis(3-mercaptobutylate), ethyleneglycol bis(2-mercaptopropionate), 1,2-propyleneglycol bis(2-mercaptopropionate), diethyleneglycol bis(2-mercaptopropionate), 1,4-butanediol bis(2-mercaptopropionate), 1,8-octanediol bis(2-mercaptopropionate), trimethylolpropane tris(2-mercaptopropionate), pentaerythritol tetrakis(2-mercaptopropionate), dipentaerythritol hexakis(2-mercaptopropionate), ethyleneglycol bis(3-mercaptoisobutylate), 1,2-propyleneglycol bis(3-mercaptoisobutylate), diethyleneglycol bis(3-mercaptoisobutylate), 1,4-butanediol bis(3-mercaptoisobutylate), 1,8-octanediol bis(3-mercaptoisobutylate), trimethylolpropane tris(3-mercaptoisobutylate), pentaerythritol tetrakis(3-mercaptoisobutylate), dipentaerythritol hexakis(3-mercaptoisobutylate), ethyleneglycol bis(2-mercaptoisobutylate), 1,2-propyleneglycol bis(2-mercaptoisobutylate), diethyleneglycol bis(2-mercaptoisobutylate), 1,4-butanediol bis(2-mercaptoisobutylate), 1,8-octanediol bis(2-mercaptoisobutylate), trimethylolpropane tris(2-mercaptoisobutylate), pentaerythritol tetrakis(2-mercaptoisobutylate) and dipentaerythritol hexakis(2-mercaptoisobutylate).

4. Photo Curable Compositions Having a Pattern

Since polymer compounds for use in the curable composition (hereinafter, referred to as a photo radical polymerizable and curable composition) of the present invention blended in the photo radical polymerization initiator have carbonyl groups in the molecule, they can be preferably used as an alkali developing photosensitive material. When the photo radical polymerizable and curable composition of the present invention is used as an alkali developing photosensitive material, it can form patterns for various resists and color filters by the preparation step described below.

Preparation step 1: A step for coating the photo radical polymerizable and curable composition of the present invention to the substrate.

Preparation step 2: A step for drying the organic solvents.

Preparation step 3: A step for exposing to light through a photomask.

Preparation step 4: A step for washing with water after development treatment in an alkali developing solution for a given period of time.

The above steps will be explained in detail hereinbelow.

4-(1) Preparation Step 1: Coating Step

In the preparation step 1, the photo radical polymerizable and curable composition of the present invention is coated on the substrate at a predetermined thickness.

As the type of the substrate, which may differ with applications, there can be mentioned films or sheets of inorganic glasses such as quartz glass, borosilicate glass and lime soda glass of which surface has been silica-coated, thermoplastic plastics such as polyester such as polyethylene terephthalate, polyolefins such as polypropylene and polyethylene, polycarbonates, polymethyl methacrylates and polysulfone, thermo-setting plastics such as epoxy resins, polyester resins and polyimide resins, plates and foils of metals such as copper, aluminum and iron, or composites of the above thermoplastic plastics or thermo-setting plastics and the above metal.

As coating methods, dip coaters, roll coaters, wire bars, flow coaters, dye coaters, spray coating, rotational coating methods such as spinner, and screen printing methods are preferably used.

Coating thickness may differ with applications, and the film thickness after drying organic solvents is preferably 0.1-200 μm. more preferably 0.5-100 μm.

4-(2) Preparation Step 2: Step of Drying Organic Solvents

Drying of the organic solvent of the sample obtained by coating in 4-(1) can be preferably accomplished in drying equipment such as a hot plate, an IR oven and a convection oven. A preferred drying condition is 40-150° C. with the drying time in the range of 10 seconds to 60 minutes. Organic solvents can also be dried under vacuum.

4-(3) Preparation Step 3: Exposure Step

Light sources for use in exposure to light include, for example, lamp light sources such as a xenon lamp, a high pressure mercury lamp, an ultra-high pressure mercury lamp, a metal halide lamp, a medium pressure mercury lamp and a low pressure mercury lamp; and laser beams such as an argon laser, a YAG laser, an excimer laser and a nitrogen laser. When specific wavelengths of radiation is used, optical filters may be used.

Means of exposure involves placing a photomask in close contact with the sample, or making an appropriate space (gap) between the sample and the photomask followed by placing the photomask and then light is exposed to the image through said photomask.

4-(4) Preparation Step 4: Alkali Development and Step of Washing with Water

The development treatment is performed using an alkali developing solution, and the resist is developed by dip, shower, paddle and the like. As such alkali developing solutions, there can be mentioned inorganic alkaline agents such as sodium carbonate, potassium carbonate, sodium silicate, potassium silicate, sodium hydroxide and potassium hydroxide, and organic alkaline agents such as diethanolamine, triethanolamine and tetraalkylammonium hydroxide. Alkali developing solutions may contain, as desired, surfactants, water-soluble organic solvents, low molecular weight compounds having hydroxyl groups or carboxyl groups, and the like. Specifically, it is preferred to add surfactants since they have properties of improving developing, image-resolving and scumming.

As surfactants for developing solutions, there can be mentioned anionic surfactants having sodium naphthalene sulfonate groups and sodium benzenesulfonate groups, nonionic surfactants having polyalkyleneoxy groups, cationic surfactants having tetraalkylammonium groups, and the like.

The methods of developing generally involve, but not limited to, dip developing, spray developing, brush developing, ultrasonic developing etc. at a developing temperature of 10-50° C., preferably 15-45° C.

After the alkali developing treatment is complete, it is preferred to wash the pattern after curing with water to remove the alkali developing solution. This procedure inhibits excessive alkali development. Because when the pattern after curing is placed in contact with the alkali developing solution for a period of time than is needed, problems may arise that the width of the pattern becomes thinner than was intended to be.

From the foregoing processes, patterns of cured products can be formed by photo radical polymerization using the curable composition of the present invention.

### EXAMPLES

The present invention will now be explained in more detail with reference to the following examples. It should be noted, however, that the present invention is not limited to these examples in any way.

Synthesis of Copolymers of Carboxyl Group-Containing (meth)acrylic Acid and Styrene or Substituted Styrene

### Synthetic Example 1

### ACP-1

To a 1-liter four-necked flask equipped with a dropping funnel, a thermometer, a condenser and a stirrer were fed 49.8 g (579 mmol) of methacrylic acid (referred to hereinafter as MA, manufactured by Mitsubishi Rayon Co., Ltd.), 31.3 g (265 mmol) of p-methylstyrene (referred to hereinafter as PMS, manufactured by DELTECH CORPORATION), 0.2 g of 2-mercaptoethanol (manufactured by Wako Pure Chemical Industries, Ltd.), and 188.0 g of methylpropyleneglycol (referred to hereinafter as PGM, manufactured by Nippon Nyukazai Co., Ltd.), and the four-necked flask was purged with nitrogen for 1 hour. After further heating to 90° C. in an oil bath, a mixture of MA 49.8 g, PMS 31.3 g, 2-mercaptoethanol 0.2 g, PGM 188.0 g, and 2,2′-azobisisobutylonitrile (referred to hereinafter as AIBN, manufactured by Wako Pure Chemical Industries, Ltd.) 2.6 g was added dropwise over 1.5 hours. After polymerizing for three hours, it was heated to 100° C., to which a mixture of 0.9 g of AIBN and 6 g of PGM was added and further polymerized for 1.5 hour, and then allowed to stand to cool. The solid in ACP-1 was 30.1% by weight, and the weight mean molecular weight in terms of polystyrene measured by GPC was 12,000.

### Synthetic Example 2

### ACP-2

To a 1-liter four-necked flask equipped with a dropping funnel, a thermometer, a condenser and a stirrer were fed MA 30.1.g (350 mmol), PMS 39.1 g (331 mmol), 2-mercaptoethanol 0.2 g, and PGM 188.0 g, and the four-necked flask was purged with nitrogen for 1 hour. After further heating to 90° C. in an oil bath, a mixture of MA 30.1 g, PMS 39.1 g, 2-mercaptoethanol 0.2 g, PGM 188.0 g, and AIBN 2.6 g was added dropwise over 1.5 hours. After polymerizing for three hours, it was heated to 100° C., to which a mixture of 0.9 g of AIBN and 6 g of PGM was added and further polymerized for 1.5 hour, and then allowed to stand to cool. The solid in ACP-2 was 26.9% by weight, and the weight mean molecular weight in terms of polystyrene measured by GPC was 13,000.

### Synthetic Example 3

### ACP-3

To a 1-liter four-necked flask equipped with a dropping funnel, a thermometer, a condenser and a stirrer were fed MA 49.8 g (579 mmol), methyl methacrylate (referred to hereinafter as MMA, manufactured by KYOEISHA CHEMICAL Co., LTD.) 26.5 g (265 mmol), 2-mercaptoethanol 0.2 g, and PGM 188.0 g, and the four-necked flask was purged with nitrogen for 1 hour. After further heating to 90° C. in an oil bath, a mixture of MA 49.8 g, MMA 26.5 g, 2-mercaptoethanol 0.2 g, PGM 188.0 g, and AIBN 2.6 g was added dropwise over 1.5 hours. After polymerizing for three hours, it was heated to 100° C., to which a mixture of 0.9 g of AIBN and 6 g of PGM was added and further polymerized for 1.5 hour, and then allowed to stand to cool. The solid in ACP-3 was 28.8% by weight, and the weight mean molecular weight in terms of polystyrene measured by GPC was 12,000.

Synthesis of Polymer Compounds

### Working Example 1

### Synthetic Example 4: Sample A

To a 500-ml four-necked separable flask equipped with a dropping funnel, a thermometer, a condenser, a stirrer, and an air-inlet tube were fed ACP-1 300 g (629 mmol as the carboxyl group), glycidyl methacrylate (referred to hereinafter as GMA, manufactured by KYOEISHA CHEMICAL Co., LTD.) 27.5 g (193 mmol), 4-hydroxybutylacrylate glycidylether (referred to hereinafter as 4HBAGE, manufactured by Nippon Kasei Chemical Co., Ltd.) 22.2 g (103 mmol), triphenyl phosphine (Tokyo Kasei Kogyo Co., Ltd.) 1.7 g, methoquinone (Kawaguchi Chemical Industry Co., Ltd.) 0.14 g, and the oil bath was heated to 100° C. while introducing the air into the reaction mixture. Ten hours later, heating was stopped and the flask was cooled. This compound was termed “Sample A.” The solid in Sample A was 31.2% by weight, and the acid value of the solid was 115. The weight mean molecular weight in terms of polystyrene measured by GPC was 17,000.

### Working Example 2

### Synthetic Example 5: Sample B

To a 500-ml four-necked separable flask equipped with a dropping funnel, a thermometer, a condenser, a stirrer, and an air-inlet tube were fed ACP-2 300 g (562 mmol as the carboxyl group), GMA 23.1 g (162 mmol), 4HBAGE 18.8 g (87.4 mmol), triphenyl phosphine 2.5 g, and methoquinone 0.19 g, and the oil bath was heated to 100° C. while introducing the air into the reaction mixture. Ten hours later, heating was stopped and the flask was cooled. This compound was termed “Sample B.” The solid in Sample B was 30.9% by weight, and the acid value of the solid was 115. The weight mean molecular weight in terms of polystyrene measured by GPC was 18,000.

### Working Example 3

### Synthetic Example 6: Sample C

To a 500-ml four-necked separable flask equipped with a dropping funnel, a thermometer, a condenser, a stirrer, and an air-inlet tube were fed ACP-1 300 g (629 mmol as the carboxyl group), GMA 32.6 g (230 mmol), 4HBAGE 14.3 g (67.0 mmol), triphenyl phosphine 1.7 g, and methoquinone 0.14 g, and the oil bath was heated to 100° C. while introducing the air into the reaction mixture. Ten hours later, heating was stopped and the flask was cooled. This compound was termed “Sample C.” The solid in Sample C was 31.3% by weight, and the acid value of the solid was 113. The weight mean molecular weight in terms of polystyrene measured by GPC was 18,000.

### Working Example 4

### Synthetic Example 7: Sample D

To a 500-ml four-necked separable flask equipped with a dropping funnel, a thermometer, a condenser, a stirrer, and an air-inlet tube were fed ACP-2 300 g (562 mmol as the carboxyl group), GMA 23.6 g (166 mmol), 4HBAGE 17.8 g (83.1 mmol), triphenyl phosphine 2.5 g, and methoquinone 0.19 g, and the oil bath was heated to 100° C. while introducing the air into the reaction mixture. Ten hours later, heating was stopped and the flask was cooled. This compound was termed “Sample D.” The solid in Sample D was 30.6% by weight, and the acid value of the solid was 116. The weight mean molecular weight in terms of polystyrene measured by GPC was 17,000.

### Working Example 5

### Synthetic Example 8: Sample E

To a 500-ml four-necked separable flask equipped with a dropping funnel, a thermometer, a condenser, a stirrer, and an air-inlet tube were fed ACP-2 300 g (562 mmol as the carboxyl group), GMA 35.4 g (249 mmol), triphenyl phosphine 2.5 g, and methoquinone 0.19 g, and the oil bath was heated to 100° C. while introducing the air into the reaction mixture. Ten hours later, heating was stopped and the flask was cooled. This compound was termed “Sample E.” The solid in Sample E was 31.0% by weight, and the acid value of the solid was 113. The weight mean molecular weight in terms of polystyrene measured by GPC was 16,000.

### Comparative Example 1

### Synthetic Example 9: Sample F

To a 500-ml four-necked separable flask equipped with a dropping funnel, a thermometer, a condenser, a stirrer, and an air-inlet tube were fed ACP-1 300 g (629 mmol as the carboxyl group), phenylglycidylether 44.5 g (296 mmol), triphenyl phosphine (manufactured by Tokyo Kasei Kogyo Co., Ltd.) 1.7 g, methoquinone 0.14 g, and the oil bath was heated to 100° C. while introducing the air into the reaction mixture. Ten hours later, heating was stopped and the flask was cooled. This compound was termed “Sample F.” The solid in Sample F was 30.1% by weight, and the acid value of the solid was 115. The weight mean molecular weight in terms of polystyrene measured by GPC was 18,000.

### Working Example 6

### Synthetic Example 9: Sample G

To a 500-ml four-necked separable flask equipped with a dropping funnel, a thermometer, a condenser, a stirrer, and an air-inlet tube were fed ACP-3 300 g (602 mmol as the carboxyl group), GMA 25.3 g (178 mmol), 4HBAGE 19.1 g (89.0 mmol), triphenyl phosphine 2.5 g, and methoquinone 0.19 g, and the oil bath was heated to 100° C. while introducing the air into the reaction mixture. Ten hours later, heating was stopped and the flask was cooled. This compound was termed “Sample G.” The solid in Sample G was 30.7% by weight, and the acid value of the solid was 116. The weight mean molecular weight in terms of polystyrene measured by GPC was 18,000.

Preparation of Photosensitive Resin Compositions

Sample A, Sample B, Sample C, Sample D, Sample E, Sample F, and Sample G were adjusted to a solid concentration of 30% by weight with PMA. To these resin solutions, trimethylolpropane triacrylate (trade name TMP-A, manufactured by KYOEISHA CHEMICAL Co., LTD.), a photo polymerization initiator, and a thiol compound were blended at the compositions shown in the following Table 1 to prepare photosensitive resin compositions (Working Examples 7-14, Comparative Example 2).

TABLE 1
Composition of various photosensitive resin compositions

| | Work. Ex. | Work. Ex. | Work. Ex. | Work. Ex. | Work. Ex. | Comp. Ex. | Work. Ex. | Work. Ex. | Work. Ex. |
|---|---|---|---|---|---|---|---|---|---|
| Name of ingredient | 7 | 8 | 9 | 10 | 11 | 2 | 12 | 13 | 14 |
| Radical polymerizable resin | Sample A | Sample B | Sample C | Sample D | Sample E | Sample F | Sample G | Sample A | Sample A |
| (solid concentration 30% by | 100 parts | 100 parts | 100 parts | 100 parts | 100 parts | 100 parts | 100 parts | 100 parts | 100 parts |
| weight) | by weight | by weight | by weight | by weight | by weight | by weight | by weight | by weight | by weight |
| Trimethylolpropane | 15 parts | 15 parts | 15 parts | 15 parts | 15 parts | 15 parts | 15 parts | 15 parts | — |
| triacrylate | by weight | by weight | by weight | by weight | by weight | by weight | by weight | by weight | |
| Irgacure 907 | 2.5 parts | 2.5 parts | 2.5 parts | 2.5 parts | 2.5 parts | 2.5 parts | 2.5 parts | 2.5 parts | 2.5 parts |
| | by weight | by weight | by weight | by weight | by weight | by weight | by weight | by weight | by weight |
| EAB-F | 0.5 parts | 0.5 parts | 0.5 parts | 0.5 parts | 0.5 parts | 0.5 parts | 0.5 parts | 0.5 parts | 0.5 parts |
| | by weight | by weight | by weight | by weight | by weight | by weight | by weight | by weight | by weight |
| trimethylolpropane tris(2- | 2.5 parts | 2.5 parts | 2.5 parts | 2.5 parts | 2.5 parts | 2.5 parts | 2.5 parts | — | 2.5 parts |
| mercaptoisobutylate) | by weight | by weight | by weight | by weight | by weight | by weight | by weight | | by weight |
| Evalution of | | | | | | | | | |
| photosensitive resin | | | | | | | | | |
| composition | | | | | | | | | |
| Photo sensitivity | 8 (good) | 10 (good) | 9 (good) | 10 (good) | 8 (good) | 0 | 7 (good) | 3 | 2 |
| evalution-1 (shape of | | | | | | — | | (passable) | (passable) |
| residual film) | | | | | | | | | |
| Photo sensitivity | 7 (good) | 10 (good) | 8 (good) | 10 (good) | 7 (good) | 0 | 2 | 0 | 0 |
| evalution-2 (shape of | | | | | | — | (passable) | — | — |
| residual film) | | | | | | | | | |

Irgacure 907: 2-methyl-1-[4-(methylthio)phenyl]-2-morpholino-propane-1-one Manufactured by Chiba Speciality Chemicals Co., Ltd.
FAB-F: 4,4′-bis(N,N-diethylamino) benzophenone Manufactured by Hodogaya Chemical Co., Ltd.

Evaluation of Photosensitive Resin Compositions Photo Sensitivity Evaluation-1

The photosensitive resin compositions and the comparative photosensitive resin compositions in Table 1 were coated on a glass substrate with a dimension of 100×100×1 mm by a spin coater to a dry film thickness of about 15 μm. After the solvent was dried off at the condition of 70° C. for 30 minutes by a hot-air cycling drier, a 21-step tablet (Hitachi Chemical Co., Ltd.) was placed on each of the coated substrates, which was then exposed to light to 200 mJ/cm² by an exposure system (manufactured by Ushio Inc., trade name Multilight ML-251A/B) with a built-in ultra high pressure mercury lamp. The amount of ultraviolet irradiated was measured by an UV integrating actiometer UIT-150 of Ushio Inc. (light detector UVD-S365). After exposure, each coated substrate was subjected to developing treatment in a 1% aqueous solution of sodium carbonate at 30° C. for one minute, and then washed in water, and dried by an air gun. Then the number of steps in which the coated films completely remained was counted. Herein, the larger the number of steps, the higher the photo sensitivity is. Furthermore, the shape of the residual film was examined by an optical microscope to judge whether it is good or not. The result is shown in Table 1.

Photo Sensitivity Evaluation-2

The photosensitive resin compositions and comparative photosensitive resin compositions in Table 1 were coated on a glass substrate with a dimension of 100×100×1 mm by a spin coater to a dry film thickness of about 15 μm. After the solvent was dried off at the condition of 70° C. for 30 minutes by a hot-air cycling drier, a 21-step tablet (Hitachi Chemical Co., Ltd.) was placed on each of the coated substrates, which was then exposed to light to 200 mJ/cm² by an exposure system (manufactured by Ushio Inc., trade name Multilight ML-251A/B) with a built-in ultra high pressure mercury lamp. The amount of ultraviolet irradiated was measured by a UV integrating actiometer UIT-150 of Ushio Inc. (light detector UVD-S365). After exposure, each coated substrate was subjected to developing treatment in a 1% aqueous solution of sodium carbonate at 30° C. for one minute, and then washed in water, and dried by an air gun. Then the number of steps in which the coated films completely remained was counted. Herein, the larger the number of steps, the higher the photo sensitivity is. Furthermore, the shape of the residual film was examined by an optical microscope to judge whether it is good or not. The result is shown in Table 1.

As can be seen from the results in Table 1, since the novel polymer compounds of the present invention that were obtained by using as raw materials a copolymer of (meth)acrylic acid and styrene or substituted styrene and a (meth)acrylic ester having epoxy groups, and then reacting them have favorable radical polymerizable properties and alkali developing properties, they can be made into polymer compound compositions having excellent surface curing properties and resistance to alkali development. On the other hand, since the resin composition of Comparative Example 2 does not have (meth)acrylic acid on the side chain (i.e. since it uses as a raw material Sample F in which ACP-1 and GMA are not reacted), it does not undergo photo-curing and hence does not provide sufficient sensitivity. It can also be seen that since the resin composition of Working Example 12 does not use styrene or substituted styrene (i.e. since it uses as a raw material Sample G prepared from ACP-3 that was prepared without using PMS in the main chain), resistance to an aqueous alkaline solution is slightly low.

### EFFECTS OF THE INVENTION

The photo radical polymerizable and curable composition of the present invention can be preferably used in resist applications such as etching resists, solder resists, color filter resists and the like.

1. A polymer compound whose side chain has a structure represented by the following Formula (I):
CH₂═C(R¹)COO(R²O)ₙCH₂CH(OH)CH₂OOC— Formula (I)
wherein R¹ represents a hydrogen atom or a methyl group, R² has one or more organic residues independently selected from the group consisting of an alkylene group, a branched alkylene group, an alkenylene group, a branched alkenylene group, a cycloalkylene group, a cycloalkenylene group and an arylene group, and n represents an integer of 0 to 1.

2. The polymer compound according to claim 1 wherein the polymer compound residue representing the main chain is a copolymer of (meth)acrylic acid and styrene and/or substituted styrene.

3. A method of preparing the polymer compound according to claim 1 comprising the following Preparation step A wherein
to a polymer compound represented by the following Formula (2):
R³—(—COOH)ₘ Formula (2)
wherein R³ is a polymer compound residue representing the main chain and m represents an integer of 2 or more is reacted one or more of compounds represented by the following Formula (3): 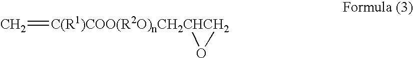
wherein R¹ represents a hydrogen atom or a methyl group, R² has one or more organic residues independently selected from the group consisting of an alkylene group, a branched alkylene group, an alkenylene group, a branched alkenylene group, a cycloalkylene group, a cycloalkenylene group and an arylene group, and n represents an integer of 0 to 1, in an additive reaction.

4. The method of preparation according to claim 3 wherein the addition reaction in the above Preparation step A is carried out in the presence of a catalyst.

5. The method of preparation according to claim 4 wherein said catalyst comprises one or more catalysts selected from the group consisting of a metal halide, a tertiary amine, a pyridine compound, a pyridinium salt, a quaternary ammonium salt, a phosphine compound, a phosphonium salt, and an imidazole compound.

6. The method of preparation according to claim 5 wherein said catalyst comprises one or more catalysts selected from the group consisting of benzyltrimethyl ammonium chloride, benzyltriethyl ammonium chloride, tetrabutyl ammonium bromide, triphenyl phosphine, ethyltriphenyl phosphonium bromide, tetraphenyl phosphonium bromide, benzyltriphenyl phosphonium chloride, and 2-methyl imidazole.

7. A curable composition comprising the polymer compound according to claim 1.

8. The curable composition according to claim 7 further comprising an ethylenic unsaturated compound.

9. The curable composition according to claim 7 further comprising a radical polymerization initiator.

10. The curable composition according to claim 9 wherein said radical polymerization initiator is a photo radical polymerization initiator.

11. The curable composition according to claim 9 comprising a polyfunctional thiol compound that has one or more than one mercapto group.

12. The curable composition according to claim 11 wherein said polyfunctional thiol is a polyfunctional thiol compound having two or more mercapto-containing groups in which the carbon atom at position α and/or position β relative to the mercapto group has a substituent group.

13. A curable composition for color filters which composition comprises a curable composition according to claim 7.

14. A cured product for color filters having a pattern that is obtained by a process wherein a curable composition according to claim 7 is coated on a substrate, which is then exposed to light and cured through a photomask, and the uncured portions are washed away with an aqueous alkaline solution.
